(19) United States
(12) Patent Application Publication
(10) Pub. No.: US 2014/0138547 A1
(43) Pub. Date: May 22, 2014

(54) HYBRID HIGH ENERGY PHOTON DETECTOR

(71) Applicant: Matthew D. Chambers, Goleta, CA (US)

(72) Inventor: Matthew D. Chambers, Goleta, CA (US)

(73) Assignee: RAYTHEON COMPANY, Waltham, MA (US)

(21) Appl. No.: 13/613,593

(22) Filed: Sep. 13, 2012

(51) Int. Cl. G01T 1/20; G01T 1/208

(52) U.S. Cl. CPC G01T 1/2018; G01T 1/2006; G01T 1/208
USPC 250/362; 250/366; 438/65

(57) ABSTRACT

An apparatus for detecting a high energy photon includes a scintillator material having an array of scintillator pixels, a photon transducer bonded to the scintillator material, and an integrated circuit coupled to the photon transducer. Each scintillator pixel is configured to receive a high energy photon and to scintillate upon interacting with the received high energy photon to generate a scintillation photon. The photon transducer is configured to generate an electrical signal indicative of detecting the high energy photon upon the photon transducer interacting with the scintillation photon generated by a scintillator pixel in the array of scintillator pixels. The integrated circuit is configured to receive the electrical signal and to provide an output signal having information related to detecting the high energy photon and identifying the scintillator pixel that interacted with the high energy photon to generate the scintillation photon.

### BACKGROUND

The present disclosure relates generally to detecting high energy photons (i.e., gamma rays and/or X-rays) with a detector built as a semiconductor detector device.

High energy photon detectors are used for various purposes such as Positron Emission Tomography (PET), back scatter imaging of high energy photons, and transmission imaging of high energy photons. For instance, an array of gamma ray detectors used in a PET scan produces a three-dimensional image of a bodily structure. Each gamma ray detector used in PET typically has a scintillator crystal coupled to a photomultiplier tube, which amplifies the light generated in the crystal by a gamma ray interaction. These gamma ray detectors are generally assembled individually and bulky. The individual detectors are then mechanically fastened together to form the array. However, image resolution may be limited due the bulkiness of each detector. That is, the minimum spacing between detectors may be limited due to the size of the detectors. In addition, fabrication costs of individual detectors can be high. Hence, it would be appreciated in various industries requiring gamma ray detector arrays, if the size and cost of the arrays could be reduced.

### SUMMARY

Disclosed is an apparatus for detecting a high energy photon. The apparatus includes a scintillator material having an array of scintillator pixels where each scintillator pixel is configured to receive a high energy photon and to scintillate upon interacting with the received high energy photon to generate a scintillation photon. A photon transducer is bonded to the scintillator material and configured to generate an electrical signal indicative of detecting the high energy photon upon the photon transducer interacting with the scintillation photon generated by a scintillator pixel in the array of scintillator pixels. An integrated circuit is coupled to the photon transducer and configured to receive the electrical signal and to provide an output signal having information related to detecting the high energy photon and identifying the scintillator pixel that interacted with the high energy photon to generate the scintillation photon.

Also disclosed is a method for detecting a high energy photon. The method includes receiving the high energy photon with a scintillator material comprising an array of scintillator pixels, each scintillator pixel being configured receive a high energy photon and to scintillate upon interacting with the high energy photon to generate a scintillation photon. The method also includes generating an electrical signal with a photon transducer that is bonded to the scintillator material and receives the scintillation photon, the electrical signal being indicative of detecting the high energy photon. The method further includes providing an output signal with an integrated circuit that is coupled to the photon transducer and receives the electrical signal, the output signal having information related to detecting the high energy photon and identifying the scintillator pixel that interacted with the high energy photon to generate the scintillation photon.

Further disclosed is a method for fabricating a detector for detecting a high energy photon. The method includes selecting a scintillator material having an array of scintillator pixels where each scintillator pixel is configured receive a high energy photon and to scintillate upon interacting with the high energy photon to generate a scintillation photon. The method also includes bonding the scintillator material to a photon transducer configured to generate an electrical signal indicative of detecting the high energy photon upon the photon transducer interacting with the scintillation photon. The method further includes coupling a readout integrated circuit to the photon transducer, the readout integrated circuit being configured to receive the electrical signal and identify a corresponding scintillator pixel from which the electrical signal is derived and to provide an output signal comprising information identifying the corresponding scintillator pixel and high energy photon detection information.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a cross-sectional view of an exemplary embodiment of a high energy photon detector fabricated on a semiconductor substrate;

FIG. 2 is a cross-sectional view of another embodiment of the high energy photon detector;

FIG. 3 is a cross-sectional view of an exemplary embodiment of an array of scintillator pixels in the high energy photon detector;

FIG. 4 depicts aspects of a mirror in the high energy photon detector;

FIG. 5 is a flow chart illustrating a method for detecting high energy photons;

FIG. 6 is a flow chart illustrating a method for fabricating a high energy photon detector; and

FIG. 7 is a graph of energy absorption coefficient versus energy for various scintillator materials.

### DETAILED DESCRIPTION

A detailed description of one or more embodiments of the disclosed apparatus and method is presented herein by way of exemplification and not limitation with reference to the Figures.

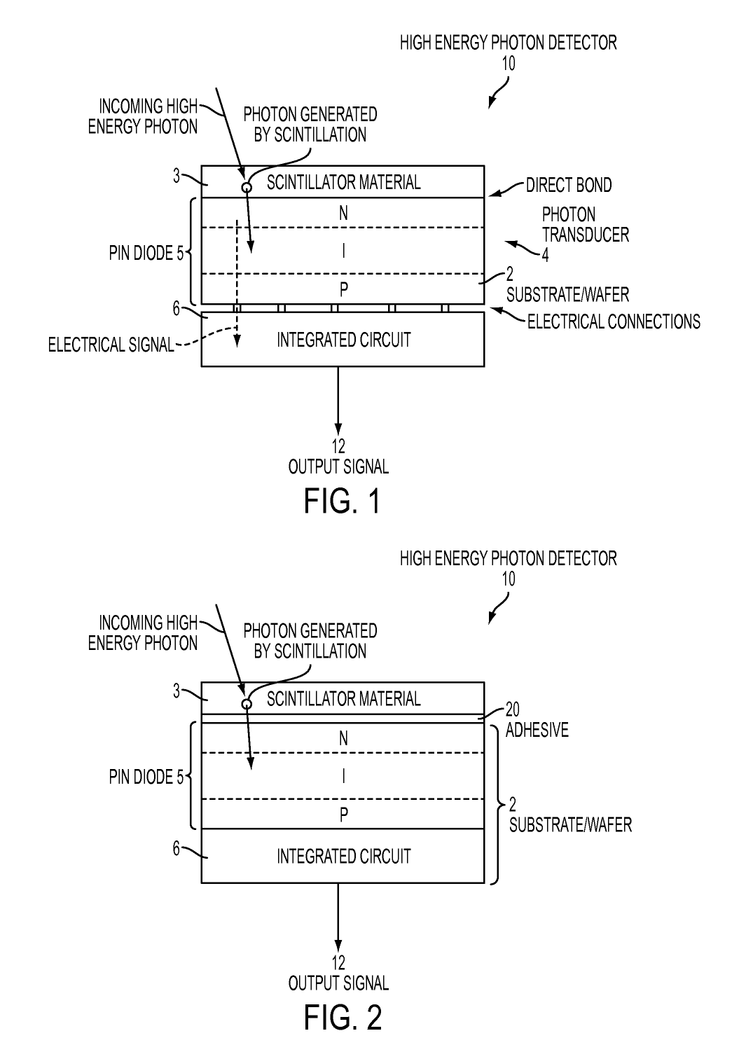

FIG. 1 illustrates a cross-sectional view of an exemplary embodiment of a high energy photon detector 10. The term “high energy photon” relates to a gamma ray, X-ray, or photon having energy greater than or equal to 10 eV. The high energy photon detector 10 is fabricated on a semiconductor substrate (or wafer) 2 using semiconductor and integrated circuit fabrication techniques such as photolithography and direct bonding. Hence in one or more embodiments, the high energy photon detector 10 may be considered as “a high energy photon detector on a chip.” The high energy photon detector 10 is configured to receive a high energy photon and provide an output signal 12 containing information related to the detection of the high energy photon. The signal information can include an indication of detection of the incoming high energy photon or measurement of energy of the incoming high energy photon or both. In addition, when there is a stream of incoming high energy photons, the high energy photon detector 10 can provide an indication as to the rate (i.e., intensity) at which the high energy photons are received. Hence, the term “detect” and the like relates to obtaining one or more of the above or similar types of information related to detected high energy photons.

Still referring to FIG. 1, an incoming high energy photon is received by a scintillator material 3 (shown as one scintillator pixel). Upon interaction with the incoming high energy photon, the scintillator material 3 scintillates and generates one or more low energy photons (i.e., ultraviolet, visible, or infrared light), which may be referred to scintillation photons. That is, the scintillator material 3 absorbs the received high energy photon and its energy and emits the absorbed energy as a low energy photon or photons. The term “low energy photon” or scintillation photon relates to a photon having energy less than 10 eV. Low energy photons are generated in the scintillator 3 due to the scintillator 3 receiving and interacting with high energy photons. The low energy photons are received by a photon transducer 4. The photon transducer 4 is configured such that the low energy photons interact with it and generate free electrical charge carriers. The free electrical charge carriers are used to generate an electrical signal (e.g., voltage and/or current) having information related to the detection of the high energy photon.

The photon transducer 4 is fabricated from a semiconductor substrate or wafer. In one or more embodiments, the photon transducer 4 is a PIN diode 5 or array of PIN diodes 5 in which each PIN diode 5 includes a P-type semiconductor region, an intrinsic (I) semiconductor region, and an N-type semiconductor region. A reverse bias electric field applied across the PIN diode(s) 5 sweeps the free carriers out of the corresponding region(s) and creates the electrical signal. In one or more embodiments, the PIN diode 5 is configured to provide avalanche multiplication of the generated electrical carriers in order to provide signal gain. In one or more embodiments, the PIN diode 5 is fabricated from a silicon substrate or wafer and may be referred as a SiPIN diode.

In general, the amount of low energy photons generated by scintillation is proportional to the energy of the incoming high energy photon. Hence, the amplitude of current generated in the photon transducer 4 may be used as an indication of the energy of the incoming high energy photon. The electrical signal generated in the photon transducer 4 may include information regarding detection of a high energy photon (e.g., a signal pulse), the energy of the detected high energy photon (e.g., amplitude of a signal pulse), and/or the intensity of a detected stream of high energy photons (e.g., pulse rate of signal).

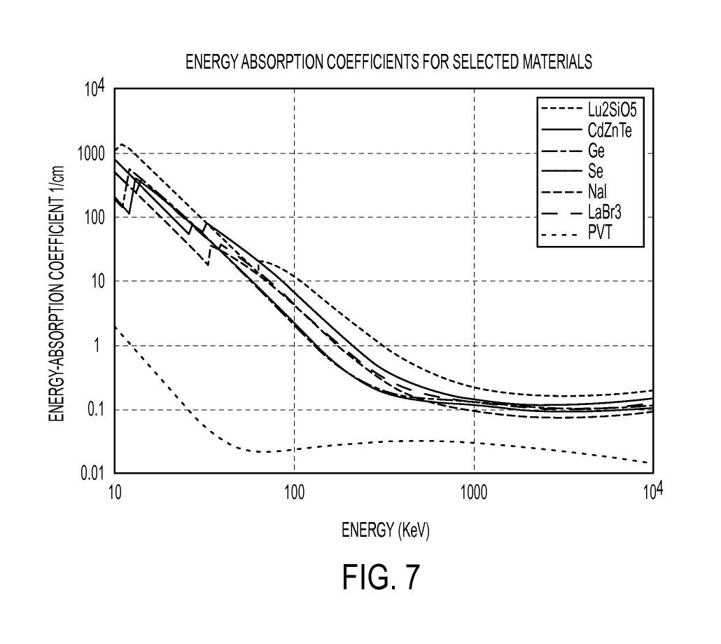

In one or more embodiments, the scintillator material 3 is a cerium-doped lutetium silicate such as LuSiO₅:Ce. An advantage of cerium-doped lutetium silicate is that it has an extremely high energy photon absorption efficiency compared to other materials (including both scintillators and semiconductor absorbers), as shown in the graph in FIG. 7.

In the embodiment of FIG. 1, the PIN diode 5 is configured such that the N-region is over the I-region and the I-region is over the P-region. Accordingly, the N-region is transparent to high energy photons allowing the incoming scintillation photons to interact in the I-region. It can be appreciated that the PIN diode 5 can have other configurations of the semiconductor regions that detect scintillation photons depending on the overall configuration of the high energy photon detector 10.

Still referring to FIG. 1, an integrated circuit 6 is configured to receive the electrical signal and provide an output signal 12 having desired information regarding the detection of the high energy photon. The output signal can be analog or digital and electrical or optical in one or more embodiments. The integrated circuit 6 may also be configured to apply the appropriate bias to the PIN diode 5 for operation of the high energy photon detector 10.

During a fabrication process for fabricating the high energy photon detector 10, the scintillator material 3 is bonded to the PIN diode 5 (or photon transducer 4). In one or more embodiments, the bonding process is direct bonding that is based on chemical bonds between the scintillator material 3 and the PIN diode 5 (or photon transducer 4). The direct bonding process in general requires that the surfaces to be bonded be sufficiently clean, flat and smooth. The surfaces are generally placed in contact at room temperature in air, a special gaseous atmosphere or a vacuum where the surfaces start to bond (i.e., pre-bonding). Then, the pre-bonded surfaces are annealed at an elevated temperature that provides a certain amount of thermal energy, which forces more groups of molecules to react among each other to form new, highly stable chemical bonds. In another embodiment, the scintillator material 3 is bonded to the PIN diode 5 (or photon transducer 4) using an adhesive 20 as illustrated in FIG. 2. Advantages of direct bonding over adhesive bonding include avoiding reflections of light rays (generated in the scintillation material) by interfaces with the adhesive 20 and avoiding absorption of the light rays by the adhesive 20.

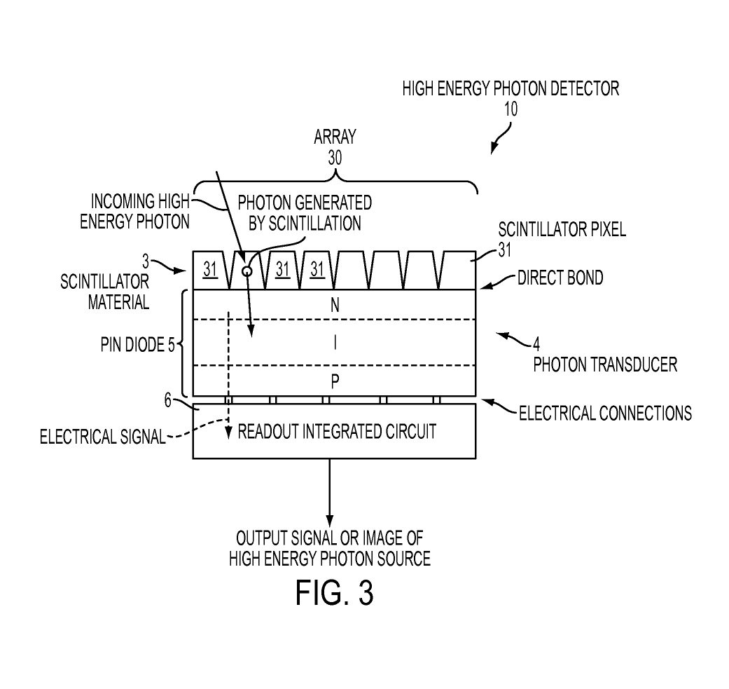

Reference may now be had to FIG. 3, which illustrates a cross-sectional view of another embodiment of the high energy photon detector 10. In the embodiment of FIG. 3, the scintillation material is divided into an array 30 of scintillator pixels 31. Each scintillator pixel 31 in the array 30 acts as an individual high energy photon detector. Hence, an image may be formed of a source emitting high energy photons by using the high energy photon detection information sensed by each scintillator pixel 31. The image is formed by plotting a representation of the sensed high energy photon detection information in a spatial configuration that corresponds to each pixel 31 in the array 30. In one or more embodiments, the array 30 of scintillator pixels 31 is formed by etching the scintillator material 3 using photolithography techniques after it is bonded to the PIN diode 5 (or photon transducer 4).

The PIN diode 5 when used with the high energy photon detector 10 having the array 30 of scintillator pixels 31 may include a plurality of PIN diodes 5 (or photon transducers 4) or discrete regions distinguished electrically or physically (i.e., forming “unit cells”) in which each unit cell in the plurality is associated with one of the scintillator pixels 31 in the array 30. Alternatively, multiple unit cells within the PIN diode 5 (or photon transducer 4) may be associated with the same single scintillator pixel 31. Alternatively, one PIN diode 5 (or photon transducer 4) or unit cell may be used with the entire array 30 or a portion of the array 30 and electronic techniques may be used to correlate the generated electrical signal with the scintillator pixel 31 that emitted the scintillation photon used to generate the electrical signal. In one or more embodiments, these electronic techniques may include using multiple connections to the PIN diode 5 (or photon transducer 4) where each connection relates to a region in the PIN diode 5 (or photon transducer 4) that corresponds to one of the pixels 31. Thus, the connection having the highest electrical signal can be correlated to the pixel 31 that scintillates to generate that current in the diode 4. The integrated circuit 6 in the embodiment of FIG. 3 is configured to measure the electrical signal generated by the PIN diode 5 (or photon transducer 4) and associate the measured electrical signal with the pixel 31 from which the electrical signal was derived. This information is then provided as the output signal from which an image of the high energy photon source may be formed. The integrated circuit 6 in embodiments having the array 30 of scintillator pixels 31 may be referred to as a Readout Integrated Circuit (ROIC).

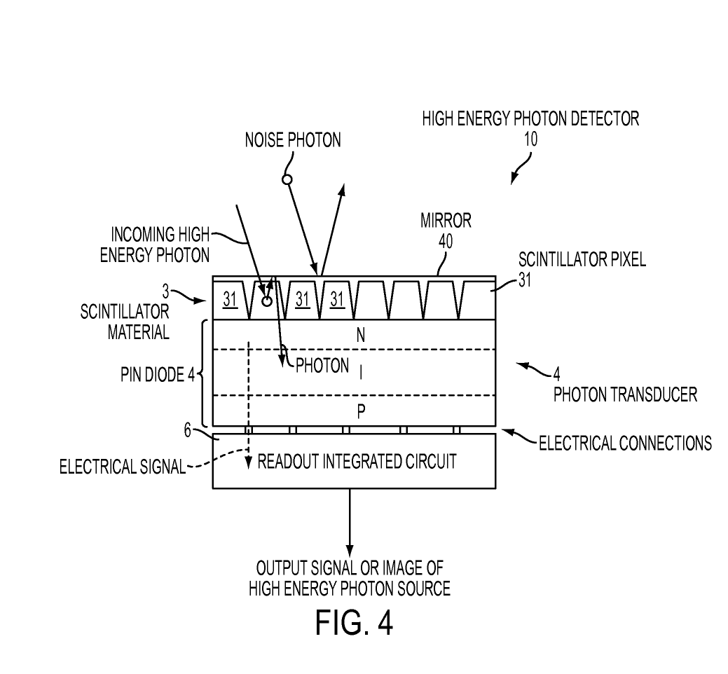

Reference may now be had to FIG. 4 depicting aspects of a mirror 40 disposed on the surface of the scintillator material 3 providing a conformal coating on the scintillator pixels 31. The conformal coating may be applied by sputtering a layer of mirror material on top of the scintillator pixels 31. The mirror 40 is configured to reflect and thus prevent scintillator fluorescence from escaping the high energy photon detector 10 to ensure high capture efficiency of the scintillation photons emitted in the scintillator material 3. In general, the mirror 40 has a thickness that allows the incoming high energy photons to pass through the mirror 40 and be absorbed in the scintillator material 3. The mirror 40 is also configured to reflect external low energy photons (i.e., noise photons) to prevent them from entering the scintillator material 3 and PIN diode 5 and, thus, prevent noise generation. In one or more embodiments, the mirror 40 includes a metal coating. In one or more embodiments, the mirror 40 may be a flat plane mirror disposed on the surface of the scintillator material 3. In one or more embodiments, the mirror 40 may be disposed away from the scintillator material 3 leaving a gap between the mirror 40 and the scintillator material 3.

The high energy photon detector 10 has several advantages over traditional gamma ray detectors such as a germanium detectors and photomultiplier tube assemblies. One advantage is that the high energy photon detector 10 lends itself to automated semiconductor or wafer fabrication and processing techniques, such as photolithography and direct bonding, which are much more easily scaled than discrete unit assembly of photomultiplier assemblies. Scaling and consequently decreased fabrication costs may mean increased applications utilizing an array of scintillator pixels. Another advantage is that wafer level direct bonding allows integration of large Lu₂SiO₃:Ce scintillator crystals, which have a higher absorption capability than germanium, silicon, CdZnTe, or scintillators traditionally deposited on Flat Panel Detectors (FPDs); this translates to lower detection thresholds, greater signal strengths, and low exposure dosages to objects subject to high energy photon interrogation.

Digital transmission high energy photon imaging is generally performed by FPDs. Traditional FPDs are constructed by depositing layers of semiconductor and scintillator materials onto a large glass substrate, wherein the scintillator is used to capture the energy of incoming photons and the semiconductor is patterned as thin film transistors (TFT) and used to covert light emitted by the scintillator into an electrical signal (voltage or current). However, the presence of contacts to the TFTs reduces the useful detector area (i.e., fill factor) of interface between the scintillator and the TFT, and the scintillator materials that are able to be deposited onto the substrates are not optimized for high energy photon absorption, which requires greater dosages of, for instance, X-rays to be delivered to the test subject. Further, since any logic circuitry is physically separated from the detecting region of the FPD, the complexity of the detectors operation is limited. The use of the high energy photon detector 10 in lieu of FPDs provides for a 100% fill factor (i.e., useful detector area) and incorporation of active integrated circuitry at the pixel level (for instance, per-pixel gain corrections or dynamic range adjustments.

Back-scatter imaging with high energy photons is traditionally performed by CdZnTe or Ge detectors, which must be cooled to cryogenic temperatures to operate. It is particularly advantageous that the use of the high energy photon detector 10 in these applications does not require cooling. It is especially advantageous for “field applications” such as mine or improved explosive device detection systems that the detectors not require cryogenic cooling.

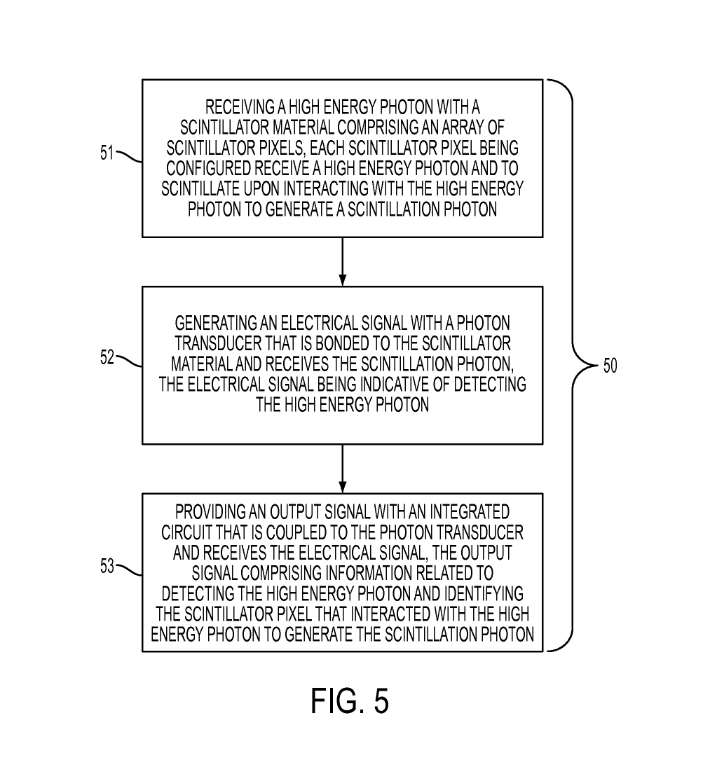

FIG. 5 is a flow chart of a method 50 for detecting a high energy photon. Block 51 calls for receiving the high energy photon with a scintillator material comprising an array of scintillator pixels, each scintillator pixel being configured receive a high energy photon and to scintillate upon interacting with the high energy photon to generate a scintillation photon. Block 52 calls for generating an electrical signal with a photon transducer that is bonded to the scintillator material and receives the scintillation photon, the electrical signal being indicative of detecting the high energy photon. Block 53 calls for providing an output signal with an integrated circuit that is coupled to the photon transducer and receives the electrical signal, the output signal comprising information related to detecting the high energy photon and identifying the scintillator pixel that interacted with the high energy photon to generate the scintillation photon. The method 50 may also include reflecting the scintillation photon towards the photon transducer using a mirror disposed on or away from the scintillator material. The method 50 may also include reflecting external low energy photons away from the scintillator material and the photon transducer.

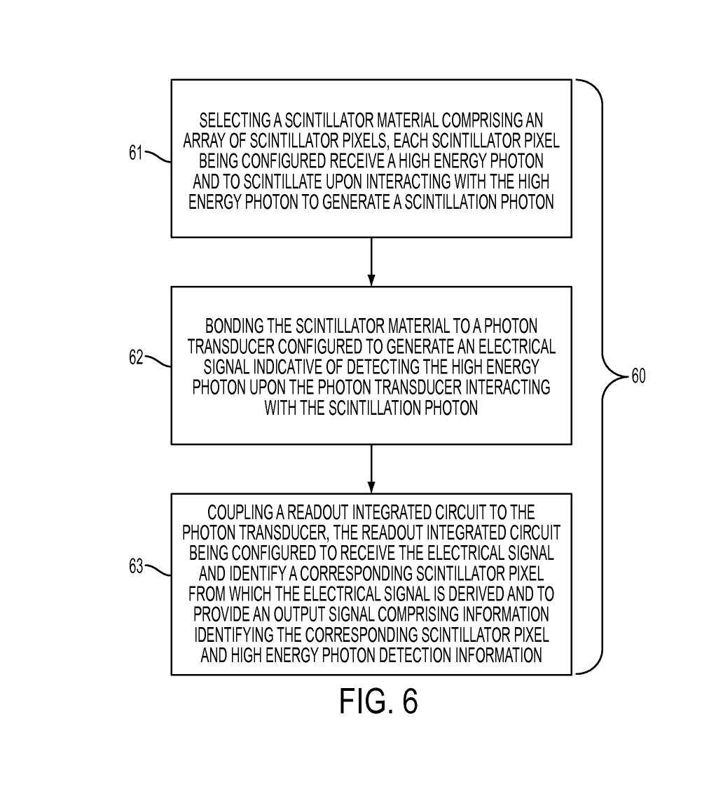

FIG. 6 is a flow chart of a method 60 for fabricating a detector for detecting a high energy photon. Block 61 calls for selecting a scintillator material comprising an array of scintillator pixels, each scintillator pixel being configured receive a high energy photon and to scintillate upon interacting with the high energy photon to generate a scintillation photon. Block 62 calls for bonding the scintillator material to a photon transducer configured to generate an electrical signal indicative of detecting the high energy photon upon the photon transducer interacting with the scintillation photon. The bonding may be direct bonding based on chemical bonds between the scintillator material and the photon transducer or adhesive bonding Block 63 calls for coupling a readout integrated circuit to the photon transducer, the readout integrated circuit being configured to receive the electrical signal and identify a corresponding scintillator pixel from which the electrical signal is derived and to provide an output signal comprising information identifying the corresponding scintillator pixel and high energy photon detection information. The method 60 can also call for etching the scintillator material to form the scintillator pixels. The method 60 can also call for disposing a mirror onto or away from the scintillator material such that the mirror reflects the scintillation photon towards the photon transducer and/or the mirror reflects an external low energy photon away from the scintillator material and the photon transducer.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The term “couple” relates to one component being coupled either directly to another component or indirectly to another component via one or more intermediate components.

While the disclosure has been described with reference to a preferred embodiment or embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. An apparatus for detecting a high energy photon, the apparatus comprising:
a scintillator material comprising an array of scintillator pixels, each scintillator pixel being configured to receive a high energy photon and to scintillate upon interacting with the received high energy photon to generate a scintillation photon;
a photon transducer bonded to the scintillator material and configured to generate an electrical signal indicative of detecting the high energy photon upon the photon transducer interacting with the scintillation photon generated by a scintillator pixel in the array of scintillator pixels; and
an integrated circuit coupled to the photon transducer and configured to receive the electrical signal and to provide an output signal comprising information related to detecting the high energy photon and identifying the scintillator pixel that interacted with the high energy photon to generate the scintillation photon.

2. The apparatus according to claim 1, wherein the information comprises an indication of detecting the high energy photon, energy of the high energy photon, or a rate of detection of a stream of received high energy photons.

3. The apparatus according to claim 1, wherein the scintillator material is bonded to the photon transducer by an adhesive.

4. The apparatus according to claim 1, wherein the scintillator material is directly bonded to the photon transducer.

5. The apparatus according to claim 1, wherein the photon transducer and the integrated circuit are fabricated from the same substrate or wafer.

6. The apparatus according to claim 1, wherein the scintillator material comprises cerium-doped lutetium silicate.

7. The apparatus according to claim 1, further comprising a mirror configured to reflect the scintillation photon towards the photon transducer.

8. The apparatus according to claim 1, further comprising a mirror configured to reflect an external low energy photon away from the photon transducer, the external low energy photon having an energy less than the energy of the high energy photon.

9. The apparatus according to claim 1, wherein the photon transducer is a SiPIN diode.

10. A method for detecting a high energy photon, the method comprising:
receiving the high energy photon with a scintillator material comprising an array of scintillator pixels, each scintillator pixel being configured receive a high energy photon and to scintillate upon interacting with the high energy photon to generate a scintillation photon;
generating an electrical signal with a photon transducer that is bonded to the scintillator material and receives the scintillation photon, the electrical signal being indicative of detecting the high energy photon; and
providing an output signal with an integrated circuit that is coupled to the photon transducer and receives the electrical signal, the output signal comprising information related to detecting the high energy photon and identifying the scintillator pixel that interacted with the high energy photon to generate the scintillation photon.

11. The method according to claim 10, further comprising reflecting the scintillation photon towards the photon transducer using a mirror disposed onto or away from the scintillator material.

12. The method according to claim 10, reflecting an external low energy photon away from the photon transducer using a mirror, the external low energy photon having an energy less than the energy of the high energy photon.

13. The method according to claim 10, further comprising creating an image of a source of the high energy photons by plotting detection information corresponding to scintillation pixels that interacted with received high energy photons.

14. The method according to claim 13, wherein plotted detection information comprises intensity of detected high energy photons.

15. A method for fabricating a detector for detecting a high energy photon, the method comprising:
selecting a scintillator material comprising an array of scintillator pixels, each scintillator pixel being configured receive a high energy photon and to scintillate upon interacting with the high energy photon to generate a scintillation photon;
bonding the scintillator material to a photon transducer configured to generate an electrical signal indicative of detecting the high energy photon upon the photon transducer interacting with the scintillation photon; and
coupling a readout integrated circuit to the photon transducer, the readout integrated circuit being configured to receive the electrical signal and identify a corresponding scintillator pixel from which the electrical signal is derived and to provide an output signal comprising information identifying the corresponding scintillator pixel and high energy photon detection information.

16. The method according to claim 15, wherein bonding comprises direct bonding of the scintillator material to the photon transducer.

17. The method according to claim 15, wherein the readout integrated circuit and the photon transducer are fabricated from the same substrate or wafer.

18. The method according to claim 15, further comprising etching the scintillator material to form the array of scintillator pixels.

19. The method according to claim 15, further comprising disposing a mirror in optical communication with the scintillator material, the mirror being configured to reflect the scintillation photon towards the photon transducer.

20. The method according to claim 15, further comprising disposing a mirror external to the scintillator material, the mirror being configured to reflect a low energy photon away from the scintillator material, the low energy photon having an energy less than the energy of the high energy photon.
